(19) United States
(12) Patent Application Publication
(10) Pub. No.: US 2012/0320913 A1
(43) Pub. Date: Dec. 20, 2012

(54) CONFIGURABLE SWITCHING OR ROUTING DEVICE

(75) Inventors: Pascal Vicat-Blanc Primet, San Francisco, CA (US); Fabienne Anhalt, Villeurbanne (FR)

(73) Assignee: Inria Institut National de Recherche en Informatique et en Automatique, Le Chesnay (FR)

(21) Appl. No.: 13/575,909

(22) PCT Filed: Jan. 11, 2011
(86) PCT No.: PCT/FR2011/050041

§ 371 Date: Jul. 27, 2012

(30) Foreign Application Priority Data
Jan. 29, 2010 (FR) 10/00368

(51) Int. Cl. H04L 12/56

(52) U.S. Cl. 370/389

(57) ABSTRACT

A switch/router comprises ports for input (In1, In2) and for output (Out1, Out2), and an interconnection matrix for linking each input port with each of the output ports with interposition of a respective memory. A controller assembly maintains management rules, including those for switching/routing, in conjunction with identifiers. A respective queue manager for each of the input ports is adapted so as, on receipt of a packet, to determine a management identifier, to interrogate the corresponding rules so as to determine the output port, to evaluate a condition on the content of the packet, and to associate it with a queue organized in the memory corresponding to the output port. Schedulers (SCHR1, SCHR2) are adapted for respectively delivering the packets at each output port, in an order deduced from an additional condition, which takes account of the management identifier.

The invention relates to switching and/or routing equipment for digital data used in communication networks in which data is exchanged in the form of packets.

Communication networks of this type include networks operating based on the Internet protocol, or IP networks.

Switching/routing equipment is widely used in these networks. They are capable of directing data packets received at their input ports toward one of their output ports, following predefined routing and switching rules. This equipment is also capable of applying management rules related to said data packets, and obeying commands or an automatic configuration program.

Such equipment is known to have high switching capacities—it can switch/route large quantities of data per unit of time—but a limited processing capacity for that data.

For some time, communication network managers have sought to improve the flexibility of such networks.

Fundamentally, the configuration of a communication network is set, at least to a great extent. This configuration is based on the installation and parameterization of data transmission elements, in particular routers/switches, which must be redeployed and/or re-parameterized in the event the network is reconfigured.

This need for flexibility has recently increased with the appearance of so-called virtual networks, made up of resources provided on request and for a predetermined length of time. One particular virtual network application relates to the IAAS (Infrastructure As a Service) concept.

In other words, one seeks to easily and temporarily modify the infrastructure of a network so as to adapt it to the needs of the moment. In particular, one tries to have several isolated logic networks cohabitate in that network simultaneously.

To that end, several players in this field have recently proposed improvements to traditional routers.

In “Intelligent logical router services,” M. KOLON, Technical report 200097-001, Juniper Networks, October 2004, a physical router is described that is capable of housing several logic routers, in which the ports of the physical router are shared and have their own routing tables. The flexibility of this type of router is limited solely to the routing operation.

In “Control plane scaling and router virtualization,” Technical report 2000261-001, Juniper Networks, February 2009, and “Router virtualization in service providers,” Technical report, Cisco Systems, virtual router models are proposed or implemented in a same piece of physical equipment. The virtual routers then share the physical resources of the equipment. Each input or output port is used by a single virtual router, always the same one. This technique does not make it possible to house a large number of virtual routers in a same physical router because a very large number of ports would then have to be provided (oversized).

Furthermore, the company Cisco Systems proposes routing equipment that implements several virtual routers for redundancy purposes in case of failure. In that case, the virtual routers all have an identical configuration.

Aside from the equipment mentioned above, also known are so-called software routers, for example those proposed in “Fairness issues in software virtual routers,” N. EGI, A GREENHALGH, M. HANDLEY, M. HOERDT, F. HUICI, and L. MATHY, in PRESTO'08: Proceedings of the ACM workshop on programmable routers for extensible services of tomorrow, New York, N.Y., USA, pages 33-38, ACM, 2008. The software routers offer great configuration flexibility. However, routers of this type have very poor routing performance compared to dedicated physical equipment. These limitations only allow them to propose virtualization of the routing (level 3 of the IP protocol) and no virtualization of the data plan (level 2 of the switch). Lastly, software routers are above all used for experimentation purposes, as described in “A Platform for High Performance and Flexible Virtual Routers on Commodity Hardware,” N. EGI, A. GREENHALGH, M. HOERDT, F. HUICI, F. PAPADIMITRIOU, M. HANDLEY, and L. MATHY, SIGCOMM 2009 poster session, August 2009, due to their poor production performance.

The invention seeks to improve this situation. The proposed equipment relates to a device for transmitting digital data of the type comprising at least one input port and output ports respectively intended to receive and deliver data packets, an interconnection matrix for linking each input port with each of the output ports by way of a respective buffer memory, a controller for managing the data packets through the switching matrix, packet schedulers organizing the delivery of the data packets to a respective output port, remarkable in that the controller is a controller assembly that maintains a management rules storage structure, including switching/routing rules, related to management identifiers, and also comprises a respective queue manager for each of the input ports, each queue manager being adapted so as, once a data packet is received at its respective input port, to determine a management identifier value for that packet, query said storage structure with said management identifier value to determine the output port of the packet, evaluate a management condition related to the content of the data packet and taken from the management rules, and, depending on the result of that evaluation, associate the data packet with a queue organized in the buffer memory corresponding to the output port of said packet in relation to the management identifier, and in that each scheduler is adapted to deliver the data packets to its respective output port in a predetermined order according to the evaluation of an additional management condition, drawn from the management rules, taking into account the value of the management identifier associated with each of the data packets to be delivered.

A router/switch of this type allows simultaneous operation of several switches, which can be qualified as virtual, based on a single piece of physical routing/switching equipment. Each of these virtual switches has its own unique configuration (number of ports, capacity of each of said ports, size of the buffer memories, routing/switching rules, operation of schedulers for the output ports), which may differ from the configuration of the other virtual routers running within the same piece of equipment.

Such equipment allows network infrastructure suppliers to best exploit the resources at their disposal. It also offers virtual network operators flexibility, since they may henceforth build virtual networks on demand, by renting out configurable virtual switches/routers upon request for a chosen period of time.

By allocating virtual switches/routers, the network operator can assign each of its clients their own virtual network. The underlying network structure is thus separated into several private virtual networks, or VPNs, which are independent of one another, and the functional characteristics of which (bandwidth, latency, service quality, routing, and others) may be parameterized and configured independently of one another.

Since the creation of the different virtual routers is done by operators on the data packets themselves, directly (level 2 of the OSI model), good isolation of these different routers is obtained. This in particular offers bandwidth and latency guarantees to the users. For the latter, everything happens as if they had separate real switches/routers.

The resources of the physical equipment, such as its buffer memory, processing capacity, the capacity of its ports, for example, are virtually shared at the lowest level of the equipment, directly in the controller assembly of the interconnection matrix. This results in excellent performance, in particular in terms of throughput.

Each virtual router can be defined individually, by stipulating the number of its ports, the capacity of each of those ports, the scheduling policy for packets at the output ports, and the different priority, routing and/or switching rules. This definition may be controlled remotely and redefined on request.

Additional, complementary or substitution features are stated below:
The management condition also pertains to the content of the data packets stored in the corresponding queue at the output port of the packets associated with the value of the management identifier of the packet in question.
The evaluation of the management condition comprises comparing the content of said stored data packets and said packet to a threshold value associated with the management identifier of said stored data packets and said packet.
The management condition at least partially pertains to a size of the data packet.
Each queue manager is adapted to maintain, in each of the buffer memories associated with its input port, a respective queue for data packets having a same management identifier value.
Each queue manager maintains as many queues as there are different management identifier values that may be assigned to a packet received at the input port associated with that queue manager.
Said data packet is stored with a relative output rank, determined by applying priority rules stored by the controller assembly in relation with the value of the management identifier of said data packet.
Each scheduler is adapted to deliver the data packets independently of the queue in which the data packets are stored.
Each scheduler is adapted so as, once the value of the management identifier of the packet to be delivered is determined, to deliver a packet from one of the corresponding queues, by applying priority rules, maintained in relation with that value of the management identifier.
Each scheduler is adapted to determine the value of the management identifier of the packet to be delivered by applying predefined priority rules.
The controller assembly executes a general scheduler determining, for each of the packet schedulers, the value of the management identifier for the packet to be delivered, by applying predefined priority rules.
The evaluation of said management condition and/or said additional management condition comprises the evaluation, for the management identifier in question, of at least one of the sizes of the group formed by a cumulative size of processed packets, a cumulative size of processed packets per unit of time, a number of packets processed and a number of packets processed per unit of time.
The controller maintains a set of priority rules for the delivery of data packets belonging to different queues, and each packet scheduler is arranged to evaluate one of those rules, after determining the value of the management identifier of the packet to be delivered, by applying management rules maintained in relation with that value of the management identifier.
The controller assembly comprises a plurality of controllers, each of said controllers being associated with a respective one of the input ports.

Also proposed is a method for transmitting digital data comprising the following steps:
receiving data packets at least at one input port,
identifying a respective output port for each data packet by applying predetermined management rules,
placing each data packet in a queue maintained between the input port and the output port identified in the preceding step,
delivering, at each of the output ports, the data packets of the queues linked to that output port, in a manner organized following a predetermined order,
remarkable in that the step for identifying the respective output port comprises the following steps:
determining a respective management identifier value for each data packet,
applying management rules, including switching/routing rules, relative to the management identifier determined in the preceding step,
and in that the step for placing each data packet in a queue comprises the following steps:
evaluating, for each data packet, a management condition pertaining to the content of that data packet and drawn from management rules relative to its management identifier,
associating, as a function of the results of the evaluation of the preceding step, the data packet with a queue organized in the buffer memory corresponding to the output port in relation with the management identifier,
and in that the step for delivering the packets comprises the following steps:
evaluating, for each of the data packets to be delivered, an additional management condition, drawn from the management rules, taking the value of the management identifier into account,
determining a respective output order of said data packets according to the evaluation of the preceding step.

Other features and advantages of the invention will appear in light of the following detailed description and the appended drawings, in which:

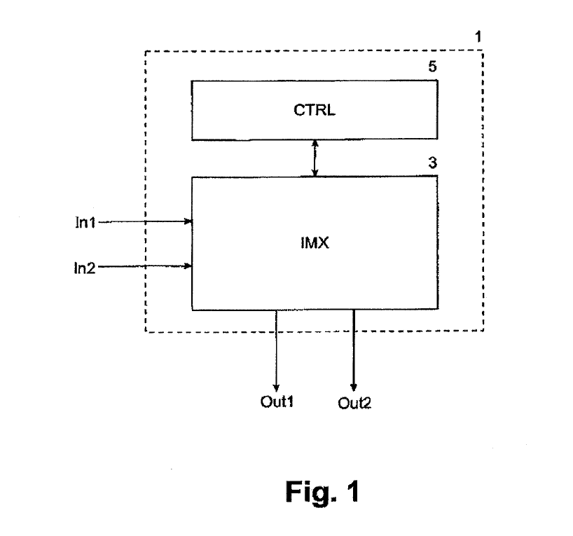

FIG. 1 is a block diagram illustrating routing equipment,

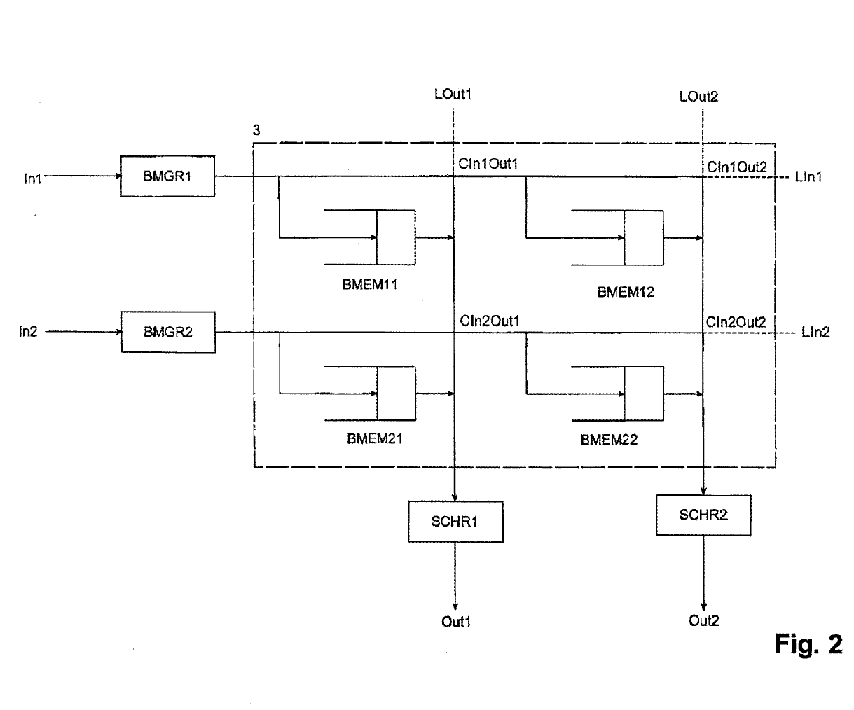

FIG. 2 is a block diagram illustrating part of the equipment of FIG. 1,

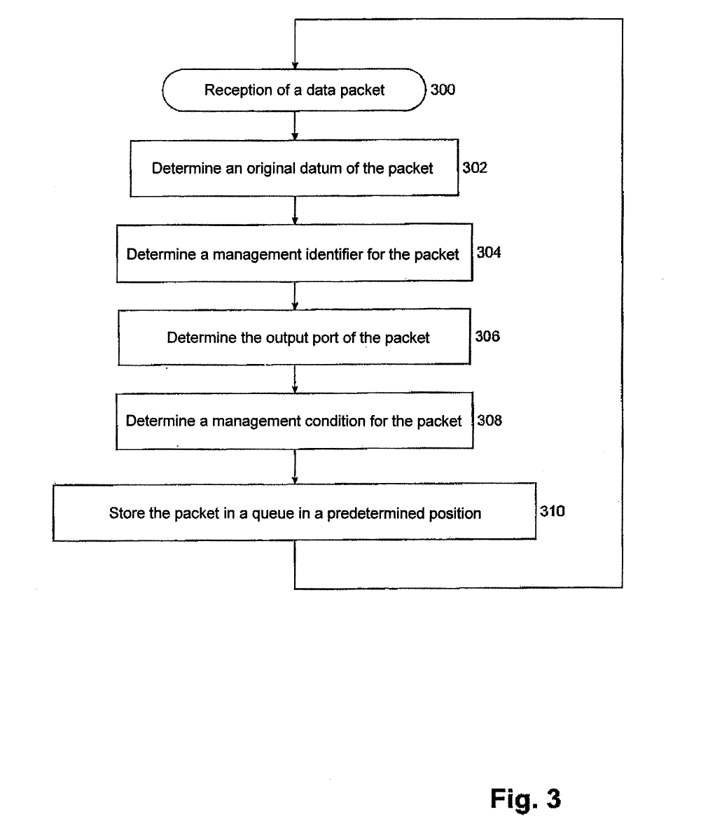

FIG. 3 is a flowchart illustrating the operation of a queue manager for the equipment of FIG. 1,

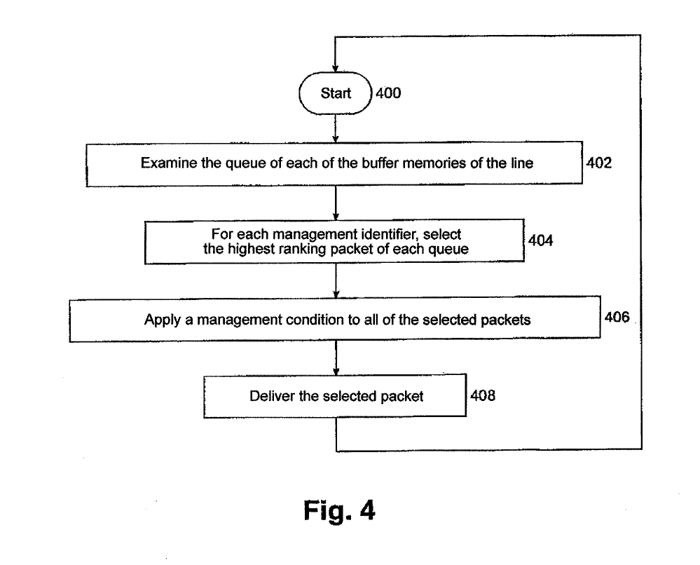

FIG. 4 is a flowchart illustrating the operation of a packet scheduler for the equipment of FIG. 1,

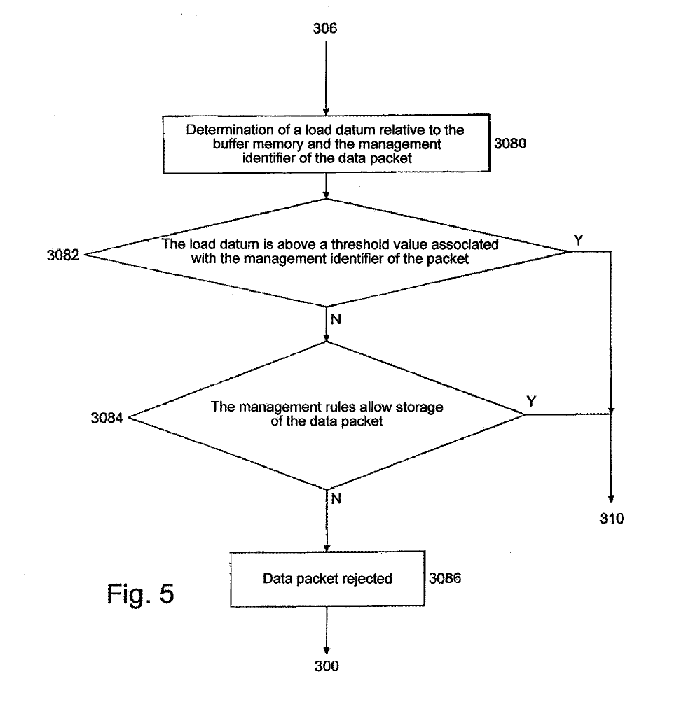

FIG. 5 is a flowchart outlining the operation 308 of FIG. 3,

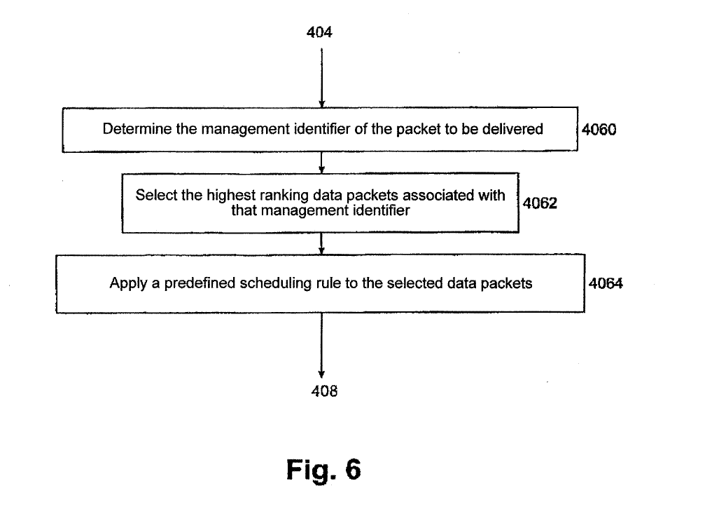

FIG. 6 is a flowchart outlining the operation 406 of FIG. 4, according to a first alternative embodiment,

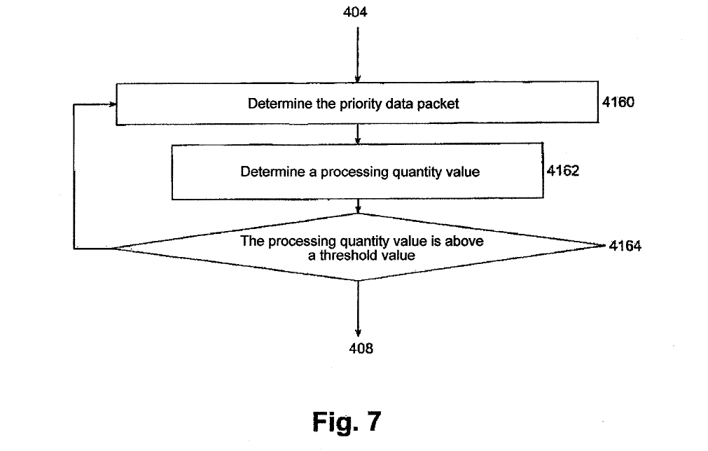

FIG. 7 is a flowchart outlining the operation 406 of FIG. 4, according to a second alternative embodiment,

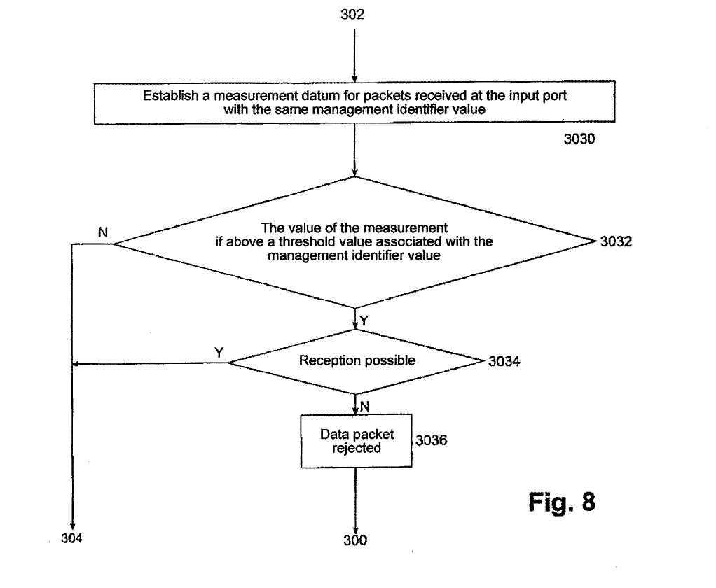

FIG. 8 is a flowchart illustrating the operation of the queue manager for the equipment of FIG. 1 in one alternative embodiment,

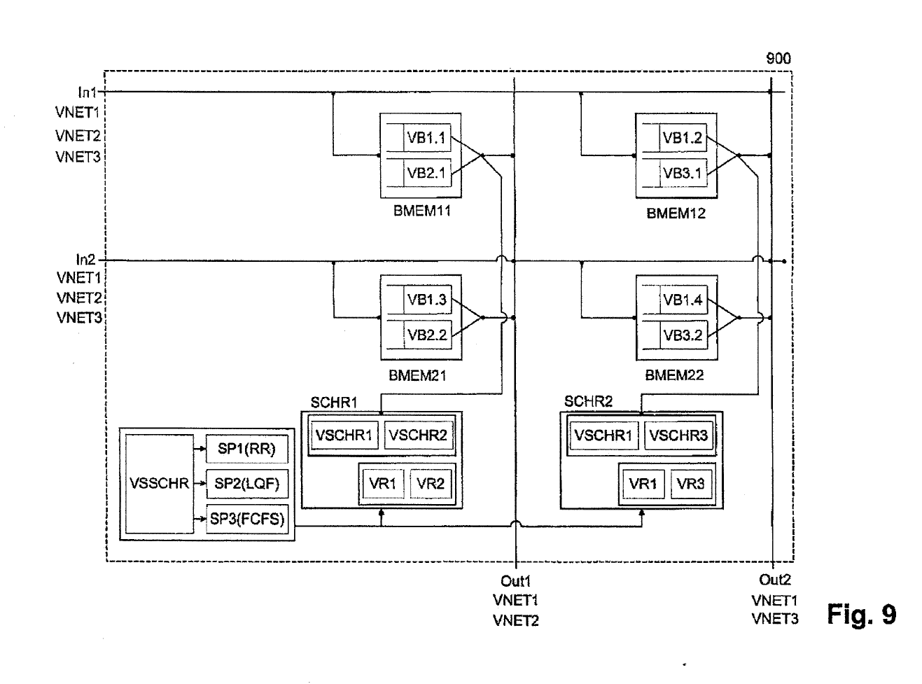

FIG. 9 is a block diagram illustrating routing equipment according to a first configuration, and

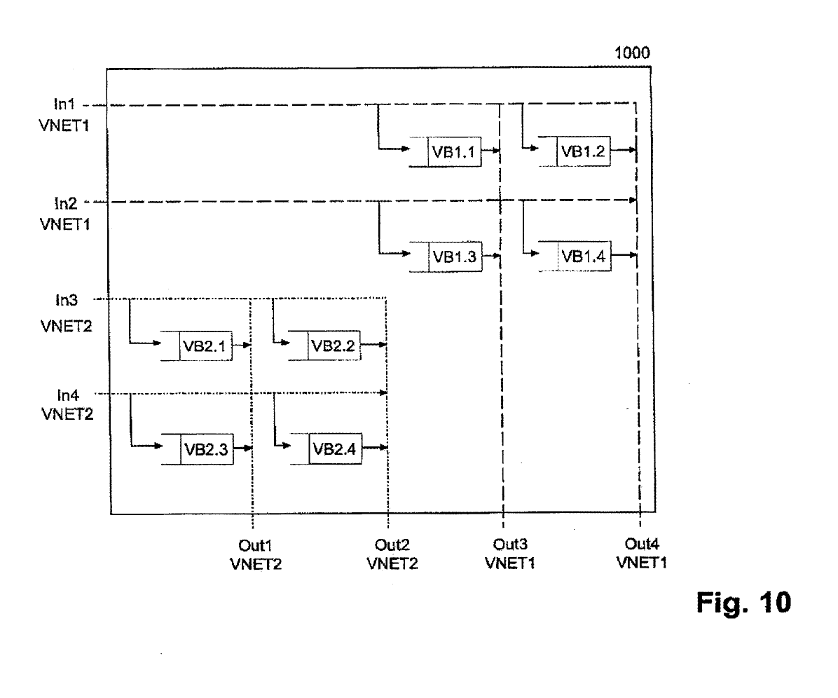

FIG. 10 is a block diagram illustrating routing equipment according to a second configuration.

FIG. 1 illustrates routing equipment, or a router 1, for use in computer networks through which digital data circulates in the form of packets, as is for example the case in so-called “IP” (Internet Protocol) networks.

The router 1 comprises so-called input ports, here a first input port In1 and a second input port In2, which may be connected to one or more IP networks so as to receive data packets. For illustration purposes only, it is assumed here that the data packets received at the first input port In1 can come from two different virtual networks, denoted VNET1 and VNET2, respectively, while the data packets received at the second input port In2 may come from the virtual network VNET1 or from another virtual network, denoted VNET3. These virtual networks may be implemented using the VLAN (virtual local area network) or MPLS (multiprotocol label switching) technology.

The router 1 also comprises so-called output ports, here a first output port Out1 and a second output port Out2, which may be connected to one or more IP networks so as to deliver data packets, for example to the networks VNET1 and VNET2.

The router 1 also comprises an interconnection matrix IMX 3, which links each input port to each of the output ports with packet transmission possibilities.

The router 1 lastly comprises a functional block designated controller assembly CTRL 5, interacting with the matrix IMX 3 to manage the circulation of the data packets from the input ports to the different output ports according to predefined rules. In particular, the controller assembly CTRL 5 ensures that the data packet arriving at an input port is delivered to one or the other of the output ports, by applying the predefined so-called “routing” rules.

The controller assembly CTRL 5 thus manages the routing of the data packets strictly speaking, which involves orienting (switching) packets between an input port and one of the output ports, as a function of its destination and/or its path, and the time organization of the conveyance of the packets through the matrix IMX 3, in particular the relative priority of the packets, the assignment of the delivery date or other, according to rules that are also predefined.

Although the present invention refers to a router as a data packet transmitting device of level 3 of the OSI model, the invention is in no way limited to that example and also applies to other transmission devices, in particular equipment for switching data in packets, or switchers.

FIG. 2 shows the matrix IMX 3 of the router 1 in more detail.

The matrix IMX 3 comprises a first input line LIn1, connected to the first input port In1, a second input line LIn2, connected to the second input port In2, a first output line LOut1, connected to the first output port Out1, and a second output line LOut2, connected to the second output port Out2.

Each of the first and second output lines LOut1 and LOut2 is interconnected both to the first input line LIn1 at a first point CIn1Out1, CIn2Out1, respectively, and to the second input line LIn2 at a second point CIn2Out1, CIn2Out2, respectively.

The matrix IMX 3 also comprises random-access memory organized in a plurality of buffer memories, respectively positioned at the interconnection points of that matrix. Here, the matrix IMX 3 comprises a buffer memory BMEM11 at point CIn1Out1, a memory BMEM12 at point CIn1Out2, a memory BMEM21 at point CIn2Out1, and a memory BMEM22 at point CIn2Out2.

Each of these input lines is controlled by a respective queue manager adapted, among other things, to organize a queue for data packets in each of the buffer memories positioned on the line it manages.

In the example of FIG. 2, a first queue manager BMGR1 controls the line LIn1 by organizing a queue in the memory BMEM11 and another queue in the memory BMEM12 for the data packets received at the port In1, while a second queue manager BMGR2, in charge of the line LIn2, organizes a queue in the memory BMEM21 and another queue in the memory BMEM22 for the packets received at the second input point In2.

The structure of the router 1 is comparable to a so-called “crosspoint-queued” structure, that structure for example being described in “The crosspoint-queued switch,” J. KANIZO and D. HAY, in IEEE INFOCOM 2009, 2009.

Furthermore, each queue manager handles storage of the data packets received at the input port of its line in one of the different queues it organizes, by applying predefined switching/routing rules.

Here, for example, the first manager BMGR1 ensures storage of the data packets received at the port In1 either in the queue of the memory BMEM11 or in the queue of the memory BMEM12, according to its own specific switching/routing rules.

Each of the output lines is controlled by a respective packet scheduler, which organizes the delivery of the data packets contained in the queues of the memories that are found on the line it manages, by applying predefined scheduling rules.

In the case at hand, a first scheduler SCHR1 controls the line LOut1 and organizes the delivery to the first output port Out1 of the data packets contained in the queues of the memories BMEM11 and BMEM22, whereas a second scheduler SCHR2, in charge of the line LOut2, organizes the delivery of the data packets maintained in the queues of the memories BMEM12 and BMEM22 to the second output port Out2.

FIG. 3 illustrates the operation of a queue manager, for example the first manager BMGR1.

In the operation 300, a data packet is received at the input port of the line controlled by the queue manager in question, here the port In1.

In the operation 302, a datum is recovered characterizing the origin of the packet received in the operation 300, i.e. identifying the virtual network from which that packet comes. Here, the packets received at the port In1 can come from the networks VNET1 or VNET2. The original datum is contained in the packet itself.

The original virtual network can be identified by different data, such as an originating IP address, a recipient IP address, a VLAN label, a service label, or others. This original datum of the packet may be found in the header of that packet, but also in an additional header if applicable. The original datum may also be deduced from any combination of data and header capable of identifying the originating virtual network according to rules, in particular transfer rules, defined in the controller assembly 5.

In the operation 304, a management identifier datum is established for the packet. This identifier determines the processing of the packet in the router 1. The management identifier is established in correspondence with the original identifier of the packet. A management table may be organized by the controller assembly 5, which maintains a link between each original identifier value and a management identifier value. For example, this table associates the value VNET1 of the original identifier with a value VS1 of the management identifier, and a value VS2 with the value VNET2 of the original identifier.

The operation 304 then involves going through the management table in question.

The management identifier is equivalent to a pointer toward a set of predefined rules determining the management of the data packet in the router 1. These rules in particular comprise routing and/or switching rules for the data packets, including one or more routing tables. These rules are maintained by the controller assembly 5 in the memory of the router 1, in relation to a management identifier value.

In other words, the controller assembly 5 maintains several different routing tables, each time associated with a different value of the management identifier. Here, the controller assembly 5 maintains a routing table in relation with the identifier VS1, designated RT1, and a different routing table, denoted RT2, in relation with the identifier VS2.

In certain cases, in particular when the origin of the data packets is established from an Internet network identifier, the value of the originating datum may be taken as the management identifier. This amounts to maintaining the management rules in correspondence with the virtual network identifiers in the assembly 5.

In the operation 306, the output port of the data packet is determined by applying routing rules maintained in the controller assembly 5 in relation with the value of the management identifier determined in the operation 304.

This operation 306 involves going through a routing table to determine on which of the output ports of the router 1 the data packet must be delivered. Here, the operation 306 involves determining whether the data packet in question must be delivered to the first output port Out1 or to the second output port Out2.

In the operation 308, one or more conditions are evaluated on the data packet in relation with the management identifier associated with it.

These conditions determine how the data packet will be stored in one of the queues controlled by the queue manager. These conditions are evaluated by applying predetermined management rules, maintained in the controller assembly 5, some of which may be specific to the value of the management identifier.

This operation 308, which will be outlined below, aims to determine whether the data packet will be stored in the buffer memory corresponding to its output port, and the relative position of that data packet in the queue maintained in that memory by the queue manager.

In the operation 310, the data packet is stored in the buffer memory corresponding to the output port determined in the operation 306. The data packet is associated with the queue maintained in that memory by the queue manager in a predetermined order according to predefined priority rules.

These rules are stored by the controller assembly 5 in relation with a management identifier value. These priority rules may depend on the condition evaluated in the operation 308.

According to a first alternative embodiment, the queue manager is adapted to maintain a single queue in each of the buffer memories of the line it manages. In this alternative, the data packet is stored in the queue of the memory connected to the output port predetermined in correspondence with the value of the management identifier established in the operation 302. The routing rules then directly determine the physical output port of the data packet.

According to a second alternative embodiment, the queue manager maintains, in each of the buffer memories that it manages, as many queues as there are different management identifier values. Each queue thus corresponds to a value of the management identifier and an output port. The data packets are not necessarily stored in correspondence with their management identifier value, since the identity of the queue comprises that information. The routing rules determine the address of the queue in which the packet must be stored as a function of the destination of that packet.

In each of the first and second alternative embodiments, the data packets are selectively stored in one of the buffer memories of the line controlled by the queue manager. The queue strictly speaking may be organized in the form of a table maintaining pointers toward data packets rather than the packets themselves.

The order of the packet is relative to the management identifier corresponding to it. In other words, this is an order in the queue relative to the other data packets (or pointers toward that data) stored in correspondence with the same management identifier value. The notion of order must be understood here in a broad sense, as encompassing all means for scheduling the data packets over time, or the pointers toward those packets. The order in question may be deduced from the rank occupied by the data packet in the queue, from an order datum stored in relation with the data packet in the queue, or from a date datum associated with that packet in that queue.

The processing then restarts in step 300, upon receiving a new data packet.

FIG. 4 provides a detailed illustration of the operation of a packet scheduler, for example the scheduler SCHR1.

In the operation 400, the scheduler begins its processing. In practice, the scheduler works at regular time intervals or is called upon once the preceding packet has been delivered to an output port. In the case where all of the queues of its line are empty, the scheduler waits for a packet to arrive in any of the queues of that line.

In the operation 402, the scheduler examines the content of the queues organized in the buffer memories connected to the line it controls. Here, the scheduler SCHR1 examines the queues organized in each of the memories BEM11 and BEM21.

In the operation 404, for each of the queues, the highest ranking packet is determined associated with each of the management identifiers.

In the operation 406, one or more conditions are applied to all of the highest ranking packets, which depend on predefined management rules, stored in the controller assembly 5. Some of these management rules may be stored in relation with a particular management identifier value. In other words, the management rules of the operation 406 may be partially specific to the virtual network from which the data packet comes. The operation 406 aims to determine which of the packets present in the different queues has the highest priority, i.e. must be delivered first.

In the operation 408, the data packet selected in the operation 406 is delivered.

And the scheduler restarts the processing in 400.

FIG. 5 outlines the operation 308 according to one embodiment of the invention.

In the operation 3080, a load datum is established for the queue intended to receive the data packet. This load datum is established taking into account the data packets of the queue having the same management identifier value as the packet being processed. The load here must be understood in the broad sense and may comprise the number of pointers stored in relation with a particular management identifier, the number of data packets, or the cumulative size of said data packets.

In the operation 3082, this load datum is compared to a threshold value stored in the controller assembly 5 in relation with the value of the management identifier under consideration. In other words, it is determined whether it is possible to store the data packet in its respective queue without exceeding a boundary value specific to the management identifier of the data packet.

If yes, the process continues with the operation 306 described above.

Otherwise, in the operation 3084, it is determined to what extent the data packet can be stored without detriment to the storage of data packets associated with other management identifiers. This amounts to temporarily increasing the storage threshold value associated with the management identifier of the data packet in question, and decreasing the storage limit value for packets associated with another identifier.

If storage of the data packet is possible, the process continues with the evaluation of operation 306.

If not, the packet in question is eliminated and processing restarts in 300.

The storage decision of the operation 3084 is subject to management rules maintained in the controller assembly 5. These rules may be multiple. In general, these rules are determined so as to optimize the occupation of the buffer memory, i.e. to prevent a data packet from not being stored, and therefore being rejected, when there is still available storage space. However, the decision intended to adapt the storage threshold value of a management identifier to avoid rejection of the data packet may cause the rejection of a data packet associated with another management identifier value. The establishment of the management rules will therefore be subject to a compromise and will be established by the router administrator after negotiation with his various clients on the service guarantees offered. For example, a first storage threshold value may be guaranteed to one user, while a second threshold value, higher than the first, is not subject to any guarantee. The difference between these threshold values corresponds to storage space that may be allocated as a priority to a different user of the router.

Furthermore, the operation 3084 allows a certain degree of flexibility in the administration of the router 1. To that end, it remains optional, and the administrator of the router in question may opt for strict sharing of the quantity of buffer memory available, i.e. leading to the rejection of a data packet for exceeding the threshold storage value even though buffer memory remains available.

FIG. 6 outlines the operation 406 according to a first alternative embodiment of the invention.

In the operation 4060, the management identifier of the packet to be delivered is determined, by applying predefined management rules, maintained in the controller assembly 5. These management tools aim to distribute the work of the packet scheduler between the different values of the management identifier. They may be multiple, and will in general result from a negotiation between the administrator of the router and the different users.

The work of the scheduler may be shared equitably, in the sense that it delivers a data packet for each management identifier in turn, or a same quantity of data. It may also be weighted by management identifier, or systematically favor the identifier that has the greatest quantity of data in the queue, or that has the highest priority. The scheduler may also wait for the first packet output date.

In the operation 4062, only the packets associated with the value of the management identifier determined in the operation 4060 are considered.

In the operation 4064, scheduling rules stored in memory in relation with the value of the management identifier in question are applied. In other words, this operation 4064 corresponds to a management step of a traditional scheduler in a network. For example, the scheduling rules may comprise delivery in turn, weighted delivery, the systematic choice of the longest queue, or others.

FIG. 7 outlines the operation 406 of a second alternative embodiment of the invention.

In the operation 4160, the highest priority data packet is determined by applying scheduling rules respectively associated with the different values of the management identifier.

In the operation 4162, a processing capacity per unit of time value is determined, taking into account the delivery of the packet in question for that value of the management identifier.

In the operation 4164, that value is compared to a threshold value maintained in the controller assembly 5 in relation with the management identifier in question.

If this value is below the threshold value, the data packet is delivered. (Operation 406)

Otherwise, the step 4160 is restarted while ignoring the data packets associated with the value of the management identifier in question.

The embodiments of FIGS. 6 and 7 are only examples, and other alternative embodiments may be considered, in particular from those examples.

Thus, for example, the scheduler may be arranged to deliver the data packets independently of the value of the management identifier associated with them, while maintaining a count of the quantities of data respectively delivered for both of the management identifiers. In that case, the scheduler may modify its mode of delivering the packets when one of the management identifiers has a count above a threshold value or when the deviation between the counts of the different identifiers becomes too significant.

FIG. 8 illustrates one alternative embodiment of the queue manager, which is deduced from the operation described in relation with FIG. 3 by the interposition of an operation between the operations 302 and 304.

In the operation 3030, a packet measurement datum for the packets received with the same management identifier value at the considered input port is established. This measurement datum may correspond to a throughput, i.e. a quantity of data per unit of time, or to a burst of value, i.e. a number of packets received per unit of time, inter alia.

In the operation 3032, this measurement datum is compared to a predetermined threshold, stored in relation with the value of the management identifier associated with that data packet in the controller 5.

If this measurement datum is below the threshold value, the process continues with the operation 304.

If not, one determines to what extent the data packet can be accepted without detriment to the data packets that would arrive in association with the different management identifier values. This calls on management rules similar to those described above for sharing a buffer memory.

If it is possible to accept the packet, the process continues with the operation 304.

If not, the packet is rejected (operation 3034).

In the embodiments described above, the data packets are processed as if they were passing through separate routers as a function of the management identifier value assigned to them.

In other words, the router 1 allows the simultaneous operation of several routers, which can be qualified as virtual. These virtual routers share the ports of the physical router, but also share its processing capacity, its buffer memory, and storage space for the management data. These virtual routers therefore appear isolated and independent of one another.

The distribution of the physical resources between the different virtual routers may be fixed or, on the contrary, may be flexible, depending on the management rules defined in the controller 5.

The management identifier can then be seen as a virtual router identifier.

Each virtual router is then defined by a number of ports, the size of the buffer memory associated with the interconnection of those ports, the reception/transmission capacities of those ports, and/or one or more scheduling disciplines of the packets to be delivered.

FIG. 9 shows a router 900 made from the router 1.

The router 900 comprises two input ports In1 and In2, respectively, and two output ports Out1 and Out2, respectively.

Each of the ports Out1 and Out2 is connected both with the port In1 and the port In2. Each time, buffer memory is associated with the interconnection between an input line and output line.

The router 900 is parameterized so as to house three virtual routers, respectively designated VS1, VS2 and VS3.

In each of the ports In1 and In2, data ports can be received coming from one of the virtual networks of the group made up of the networks VNET1, VNET2 and VNET3.

Packets intended for the virtual networks VNET1 and VNET2 can be delivered to the port Out1, while packets intended for the virtual networks VNET1 and VNET3 can be delivered to the second output port Out2.

The virtual router VS1 thus uses the two input ports In1 and In2 and the two output ports Out1 and Out2, while each of the virtual routers VS2 and VS3 uses the two input ports In1 and In2 and a single output port Out1 or Out2.

Two queues VB1.1 and VB2.2 respectively belonging to the router VS1 and the router VS2 are maintained in the memory BMEM11. Queues VB1.2 and VB3.1 respectively belonging to the virtual routers VS1 and VS3 are maintained in the memory BMEM12.

Similarly, the memory BMEM21 houses a queue VB1.3 and a queue VB2.2 respectively belonging to the routers VS1 and VS2, while a queue VB1.4 and a queue VB3.2 respectively belonging to the routers VS1 and VS3 are housed in the memory BMEM22.

The first scheduler SCHR1 operates a first virtual scheduler, denoted VSCHR1, and a second virtual scheduler, denoted VSCHR2, respectively belonging to the virtual router VS1 and the virtual router VS2.

Similarly, the second scheduler SCHR2 operates a first virtual scheduler VSCHR1, belonging to the virtual router VS1, and a third virtual scheduler VSCHR3, belonging to the virtual router VS3.

A general scheduler, or virtual router scheduler VSSCHR, selects, upon each scheduling decision, one of the virtual routers sharing a same output port by calling on its respective scheduler module.

This respective scheduler module, i.e. VSCHR1 or VSCHR2 for the first output port Out1, and VSCHR1 or VSCHR3 for the second output port Out2, selects one of the queues associated with the virtual router VS and the output line to which it belongs, so as to take a packet out of the queue in question.

For example, when a delivery decision must be made at the port Out1, the general scheduler VSSCHR chooses between the scheduler VSCHR1 and the scheduler VSCHR2. If, for example, the scheduler VSCHR2 is selected, the latter selects a packet from among the packets contained in the queue VB2.1 and those of the queue VB2.2.

This delivery is done according to scheduling rules that may be specific to each of the virtual schedulers.

Here, the router 900, in reality the controller assembly 5 associated with that router 900, maintains a set of scheduling policies that each of the schedulers SCHR1 and SCHR2 can call upon, according to the scheduling policy established the corresponding virtual routers. In a certain way, the scheduling policies may themselves be seen as schedulers or as scheduling modules.

The scheduling policies for example comprise the “round robin” policy (SP1 policy), “the longest queue first” policy, denoted LQF, or the “first come first serve” policy, denoted FCFS.

The general scheduler VSSCHR, and the set of scheduling rules that may be associated therewith, can be stored in a central module of the interconnection matrix.

Each of the schedulers SCHR1 or SCHR2, which act like processors, can load the general scheduler VSSCHR and a combination of scheduling rules so as to deliver packets contained in the different queues. In practice, each of the first scheduler SCHR1 and second scheduler SCHR2 can load one instance of the general scheduler through a virtual router.

Here, a register is also associated with each of the output ports Out1 and Out2 to maintain the status of the associated scheduler, for example the identity of the queue having delivered the last output packet.

Each of the registers is divided into a logical set of isolated spaces so as to keep the statuses of each of the virtual routers VS1 to VS3 separately.

FIG. 10 shows a router 1000 resulting from the configuration of a physical router similar to the router 1 described above, with four input ports and four output ports.

The router 1000 here maintains two virtual routers VS1 and VS2 that share the input and output ports.

For example, the input ports In1 and In2 and output ports Out3 and Out4 are intended to receive and/or deliver packets of the same virtual network VNET1, while the input ports In3 and In4 and output ports Out1 and Out2 are intended to receive and/or deliver packets of a same virtual network VNET2.

In this configuration, the router 1000 perfectly isolates the data from the networks VNET2 and VNET3. This configuration is called segmentation, because no physical port and no buffer memory are shared. Each virtual router has schedulers dedicated to its dedicated ports, as if several physical switches/routers were housed in a same housing.

We have described a router 1 capable of running several virtual routers, simultaneously, with good data isolation.

The router 1 described above has an interconnection matrix with a buffer memory shared by the different interconnection points. This first comprises the case of an interconnection matrix physically having a dedicated memory module for each of the interconnection points. This also comprises the case where one of the memory modules is shared between said different interconnection points.

In the described embodiments, each of the first and second scheduler acts to deliver, in turn, packets associated with one or the other of the management identifier values. For these packets, the priority rules can depend on the value of the identifier. In other words, the first and second schedulers can apply different scheduling policies, depending on the value of the management identifier of the processed packet. Lastly, each of the first and second scheduler operates as if it were running several schedulers, or several scheduling modules, in turn, each scheduler acting for a particular value of the management identifier. When the controller determines the value of the management identifier of the packet to be delivered to an output port, it acts as if it were running a general scheduler determining which of the scheduler modules must operate at a given moment.

Similarly, a queue manager may be seen as in reality running several queue managers, or queue management modules, each of said managers acting for a particular value of the management identifier. Here again, the role of the controller assembly 5 may sometimes be likened to a general scheduler determining which of said queue management modules must operate at a given moment.

Lastly, the controller assembly 5 may be seen as running a general scheduler distributing the physical resources of the router between the different virtual routers housed in that router 1.

For clarity reasons, the controller assembly 5 has been described and illustrated as being a single piece. However, the controller assembly 5 may comprise a plurality of controllers. In particular, the controller assembly 5 may comprise at least one controller per input line to optimize performance. This then results in an architecture that allows the parallel operation of said controllers. This does not present any major technical difficulties, unlike the routers/switches of the state of the art. The control tasks are thus distributed.

The invention is not limited to the embodiments of the invention described above, but encompasses all alternatives that one skilled in the art may consider.

1. A device for transmitting digital data of the type comprising:
at least one input port and output ports respectively intended to receive and deliver data packets,
an interconnection matrix for linking each input port with each of the output ports with interposition of a respective buffer memory,
a controller for managing the data packets through the switching matrix,
packet schedulers organizing the delivery of the data packets to a respective output port, wherein
the controller is a controller assembly that maintains a management rules storage structure, including switching/routing rules, related to management identifiers, and also comprises a respective queue manager for each of the input ports, each queue manager being adapted so as, once a data packet is received at its respective input port,
to determine a management identifier value for that packet,
to query said storage structure with said management identifier value to determine the output port of the packet,
to evaluate a management condition related to the content of the data packet and taken from the management rules, and, depending on the result of that evaluation,
to associate the data packet with a queue organized in the buffer memory corresponding to the output port of said packet in relation to the management identifier,
and in that each scheduler is adapted to
deliver the data packets to its respective output port in a predetermined order according to the evaluation of an additional management condition, drawn from the management rules, taking into account the value of the management identifier associated with each of the data packets to be delivered.

2. The device according to claim 1, wherein the management condition also pertains to the content of the data packets stored in the corresponding queue at the output port of the packets associated with the value of the management identifier of the packet in question.

3. The device according to claim 2, wherein the evaluation of the management condition comprises comparing the content of said stored data packets and said packet to a threshold value associated with the management identifier of said stored data packets and said packet.

4. The device according to claim 1, wherein the management condition at least partially pertains to a size of the data packet.

5. The device according to claim 1, wherein each queue manager is adapted to maintain, in each of the buffer memories associated with its input port, a respective queue for data packets having a same management identifier value.

6. The device according to claim 5, wherein each queue manager maintains as many queues as there are different management identifier values that may be assigned to a packet received at the input port associated with that queue manager.

7. The device according to claim 1, wherein said data packet is stored with a relative output rank, determined by applying priority rules stored by the controller assembly in relation with the value of the management identifier of said data packet.

8. The device according to claim 1, wherein each scheduler is adapted to deliver the data packets independently of the queue in which the data packets are stored.

9. The device according to claim 1, wherein each scheduler is adapted so as, once the value of the management identifier of the packet to be delivered is determined, to deliver a packet from one of the corresponding queues, by applying priority rules, maintained in relation with that value of the management identifier.

10. The device according to claim 1, wherein each scheduler is adapted to determine the value of the management identifier of the packet to be delivered by applying predefined priority rules.

11. The device according to claim 1, wherein the controller assembly executes a general scheduler determining, for each of the packet schedulers, the value of the management identifier for the packet to be delivered, by applying predefined priority rules.

12. The device according to claim 1, wherein the evaluation of said management condition and/or said additional management condition comprises the evaluation, for the management identifier in question, of at least one of the sizes of the group formed by a cumulative size of processed packets, a cumulative size of processed packets per unit of time, a number of packets processed and a number of packets processed per unit of time.

13. The device according to claim 1, wherein the controller maintains a set of priority rules for the delivery of data packets belonging to different queues, and each packet scheduler is arranged to evaluate one of those rules, after determining the value of the management identifier of the packet to be delivered, by applying management rules maintained in relation with that value of the management identifier.

14. The device according to claim 1, wherein the controller assembly comprises a plurality of controllers, each of said controllers being associated with a respective one of the input ports.

15. A method for transmitting digital data comprising the following steps:
a. receiving data packets at least at one input port,
b. identifying a respective output port for each data packet by applying predetermined management rules,
c. placing each data packet in a queue maintained between the input port and the output port identified in step b),
d. delivering, at each of the output ports, the data packets of the queues linked to that output port, in a manner organized following a predetermined order,
wherein
step b. comprises the following steps:
b.1 determining a respective management identifier value for each data packet,
b.2 applying management rules, including switching/routing rules, relative to the management identifier determined in step b1,
step c. comprises the following steps:
c.1 evaluating, for each data packet, a management condition pertaining to the content of that data packet and drawn from management rules relative to its management identifier,
c.2 associating, as a function of the results of the evaluation step c1, the data packet with a queue organized in the buffer memory corresponding to the output port in relation with the management identifier,
step d. comprises the following steps:
d.1 evaluating, for each of the data packets to be delivered, an additional management condition, drawn from the management rules, taking the value of the management identifier into account,
d.2 determining a respective output order of said data packets according to the evaluation of step d1.
